(19) United States
(12) Patent Application Publication
(10) Pub. No.: US 2008/0215962 A1
(43) Pub. Date: Sep. 4, 2008

(54) PC-METADATA ON BACKSIDE OF PHOTOGRAPH

(75) Inventors: Sanna BELITZ, Helsinki (FI); Andreas MYKA, Helsinki (FI); Timo SINISALMI, Vantaa (FI); Jorma SUUTARINEN, Porvoo (FI); Daniel Lehtovirta, Espoo (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/680,343

(22) Filed: Feb. 28, 2007

(51) Int. Cl. G06F 17/00; G06F 3/048

(52) U.S. Cl. 715/232; 715/230; 715/764

(57) ABSTRACT

A method including selectively displaying a content side or a backside, respectively, of a digital media content, wherein the backside includes an area for notes; and storing notes of the area as meta data to the digital media content is disclosed. A corresponding apparatus, user interface, and computer program is also disclosed.

### FIELD

The disclosed embodiments relate to a method for assigning meta data to digital media content, an apparatus in which the method is performed, a user interface, and a computer program for implementing the method.

### BACKGROUND

Nowadays, media content, which nowadays is mostly digitally stored, is often handled in a number of apparatuses, such as mobile phones, digital cameras, media players, etc. Handling, such as sharing, copying, making printouts, etc., is much facilitated through the use of these apparatuses. However, the personal approach in handling the content items has been suffering. Therefore, there is a need for improving handling of media content stored in an apparatus.

### SUMMARY

In view of the above, it would be advantageous to solve or at least reduce the problems discussed above. In particular, it would be advantageous to provide an intuitive way of assigning meta data to media content.

In old times, media, such as photographs, press cuttings, etc., were kept in photo albums, scrap books, etc. The handling of the contents were physical, with abilities to make notes on the content items, such as writing on the backside of a photograph. The disclosed embodiments are based on the understanding that making notes in the old time way, as described above, was very intuitive for a user. The disclosed embodiments are further based on the idea that principles of these intuitive assignments of notes to media content may be introduced into the handling of digital media content in an apparatus.

According to a first aspect of the disclosed embodiments, there is provided a method comprising selectively displaying a content side or a backside, respectively, of a digital media content, wherein said backside comprises an area for notes; and storing notes of said area as meta data to said digital media content.

The method may further comprise enabling adding or editing notes in said area when said backside is selected for displaying.

The method may further comprise inputting a text in said area; and storing said text as meta data to said digital media content.

The method may further comprise inputting an image in said area by actuating a touch sensitive matrix; and storing said image as meta data to said digital media content.

The method may further comprise receiving a user input indicating to toggle between said sides. The user input may be any of a group comprising an arc movement input on a touch sensitive matrix, turning a rotatable input means, pressing a soft key, a navigation key, and a dedicated key.

The method may further comprise animating a change from the present side to the side to be displayed.

According to a second aspect of the disclosed embodiments, there is provided an apparatus comprising a memory arranged to store a digital media content; a display, and an input receiver, wherein said apparatus is arranged to selectively display a content side or a backside, respectively, of said digital media content on said display, wherein said backside comprises an area for notes, and said memory is arranged to store notes of said area as meta data to said digital media content.

The apparatus may further comprise a note input arranged to enable adding or editing of notes in said area when said backside is displayed.

The apparatus may further comprise a text input arranged for enabling input of a text in said area; and said memory is arranged to store said text as meta data to said digital media content.

The apparatus may further comprise a touch sensitive matrix arranged for enabling input of an image in said area by actuation of said touch sensitive matrix; and said memory is arranged to store said image as meta data to said digital media content. The input receiver may be arranged to receive a user input on selection of side to be displayed among said content side and said backside. The user input may be any of a group comprising an arc movement input on a touch sensitive matrix, turning a rotatable input means, pressing a soft key, a navigation key, and a dedicated key.

The apparatus may be arranged to animate a change from the present side to the side to be displayed in said display.

According to a third aspect of the disclosed embodiments, there is provided a computer-readable medium having stored thereon a data structure, comprising control instructions for causing an apparatus to perform the method according to the first aspect of the disclosed embodiments.

According to a fourth aspect of the disclosed embodiments, there is provided an apparatus comprising means for performing the method according to the first aspect of the disclosed embodiments.

According to a fifth aspect of the disclosed embodiments, there is provided a user interface comprising

a display, and an input receiver, wherein the user interface is arranged to selectively display a content side or a backside, respectively, of a digital media content on said display, wherein said backside comprises an area for notes, and said input receiver is arranged to enable adding or editing of notes in said area when said backside is displayed.

The input receiver may further comprise a touch sensitive matrix arranged for enabling input of an image in said area by actuation of said touch sensitive matrix.

The input receiver may be arranged to receive a user input on selection of side to be displayed among said content side and said backside.

As will be readily understood by a person skilled in the art, any of the above demonstrated features of the various aspects of the disclosed embodiments may be combined in any suitable configuration.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the disclosed embodiments will appear from the following detailed disclosure, from the attached dependent claims as well as from the drawings.

### BRIEF DESCRIPTION OF THE DRAWINGS

The above, as well as additional objects, features and advantages of the disclosed embodiments, will be better understood through the following illustrative and non-limiting detailed description of preferred embodiments of the disclosed embodiments, with reference to the appended drawings, where the same reference numerals will be used for similar elements, wherein:

FIG. 1 illustrates a use case of the disclosed embodiments;

FIG. 2 illustrates a use case of the disclosed embodiments;

FIG. 3 is schematic view of an apparatus according to an embodiment of the disclosed embodiments;

FIGS. 4 to 8 illustrates inputs for changing between content side and virtual backside according to different embodiments of the disclosed embodiments;

FIG. 9 illustrates selectable states according to a method according to an embodiment of the disclosed embodiments;

FIG. 10 is a flow chart schematically illustrating optional method steps performed in a virtual backside state demonstrated with reference to FIG. 9;

FIG. 11 illustrates a computer readable medium according to an embodiment of the disclosed embodiments; and

FIG. 12 illustrates a use case for the disclosed embodiments.

### DETAILED DESCRIPTION OF PREFERRED EMBODIMENTS

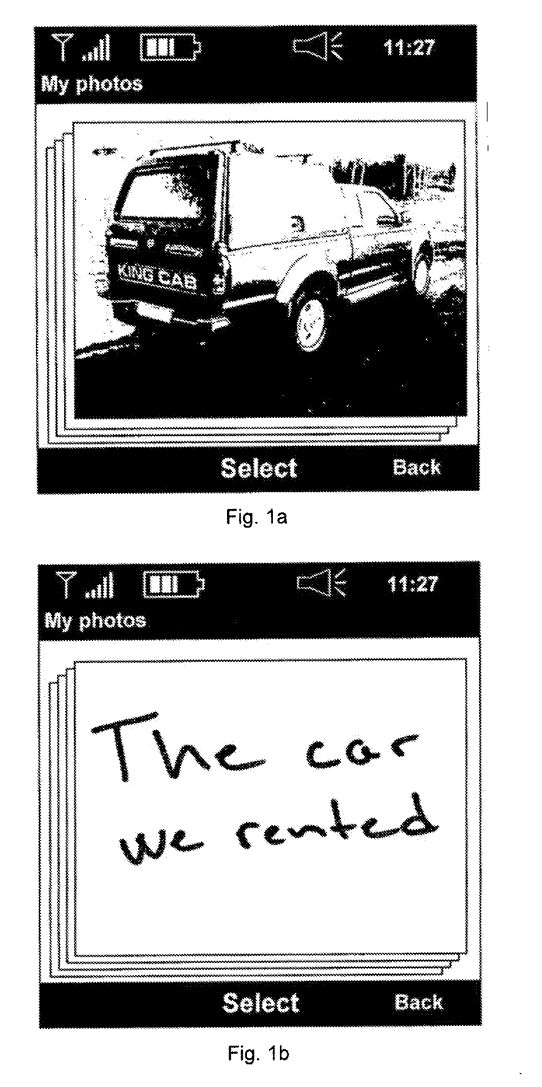

FIG. 1 illustrates a use case of the disclosed embodiments, where FIG. 1a illustrates a digital media content being rendered, here a photograph being viewed, and FIG. 1b illustrates a virtual backside of the digital media content, here the backside of the photograph, where notes related to the digital media content can be made, here as a handwritten note.

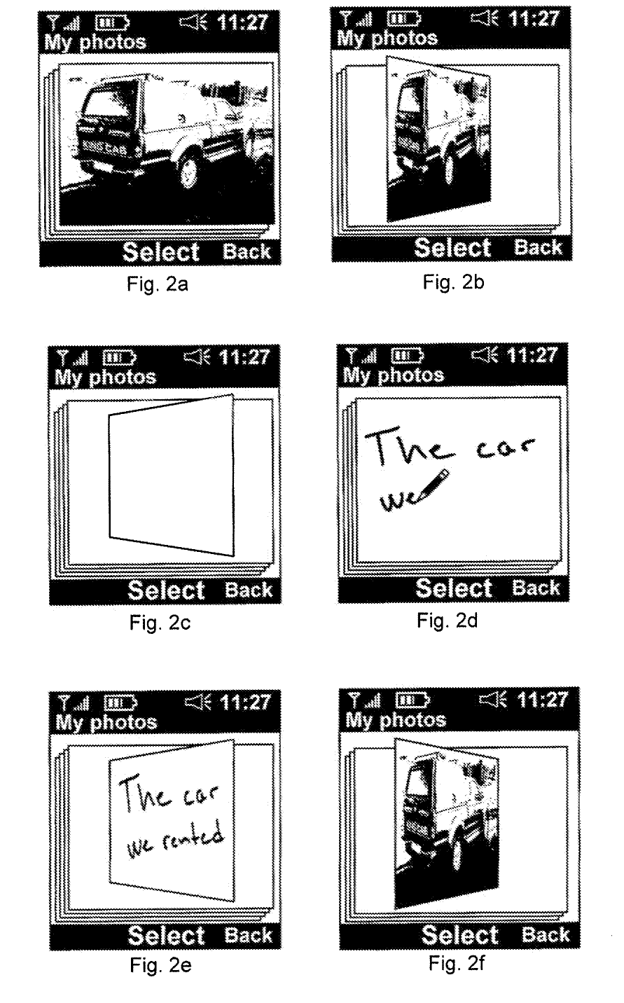

FIG. 2 illustrates a use case of the disclosed embodiments. For the sake of illustration of the general principle, the same digital media content and note as illustrated in FIG. 1 is used, but as can be readily understood, the content and note are chosen only for illustrative purpose, and any digital media content and any note can be used. For example the digital media content can comprise a multimedia content comprising audio and video components, and the note can be any information provided by a user or other. For example, the digital media content can be a musical piece, wherein the viewed image is a record sleeve, and the notes for example are track information, the virtually signed sleeve, or simply the notes of the user, such as “good floor filler”. Returning to the illustrated use case, FIG. 2a illustrates an image of the digital media content, here a photo, while FIG. 2b and FIG. 2c illustrate an animation of the photo being flipped over to reach the position illustrated in FIG. 2c, where the user writes a note on the virtual backside of the photo. FIG. 2e and FIG. 2f illustrate an animation of the photo being flipped back to the starting position, as illustrated in FIG. 2a.

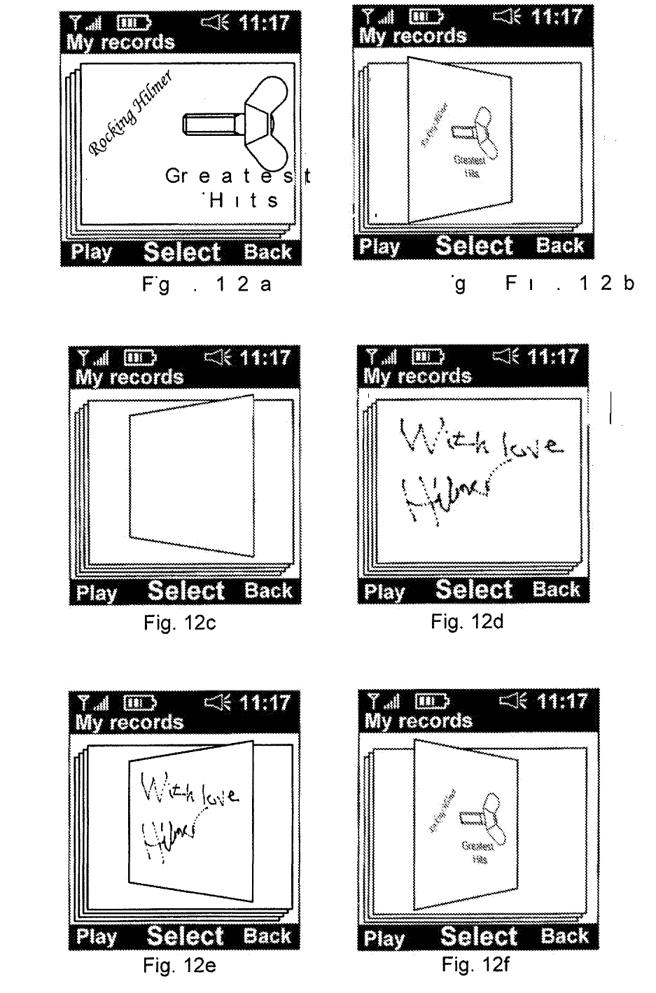

FIG. 12 illustrates another use case of the disclosed embodiments. In this example, the digital media content comprises a record, wherein the displayed item is an image of the record cover, but illustrates that the content can comprise any multimedia content comprising audio and video components, and the note can be any information provided by a user or other. In this example, the digital media content is a musical piece, wherein the viewed image is a record sleeve, and the notes comprises a signing by the artist, which is presented associated with the record sleeve. Returning to the illustrated use case, FIG. 12a illustrates an image of the digital media content, here a record cover, while FIG. 12b and FIG. 12c illustrate an animation of the record cover being flipped over to reach the position illustrated in FIG. 12c, where the record can be signed by the artist as a note on the virtual backside of the record sleeve. Signing can for example be done directly on the apparatus, or remotely via a communication network. FIG. 12e and FIG. 12f illustrate an animation of the photo being flipped back to the starting position, as illustrated in FIG. 12a.

As can be readily understood, use of the principles of the invention can be performed in a huge variety, and with all different types of digital content.

Flipping between the content side and the virtual backside of the content can be performed in a multitude of ways, such as making an arc movement on a touch sensitive area, such as a touch sensitive display, a touch pad, a touch rotator input, etc., or rotating a rotator input, pressing a soft key which is assigned the function for flipping, using a navigation key, such as a four-way navigator, or actuating a dedicated flipping key, if that is present. More options for performing flipping can be presented, and is preferably chosen in such a way that it is intuitive to the user, and preferably in line with the general build-up of the user interface.

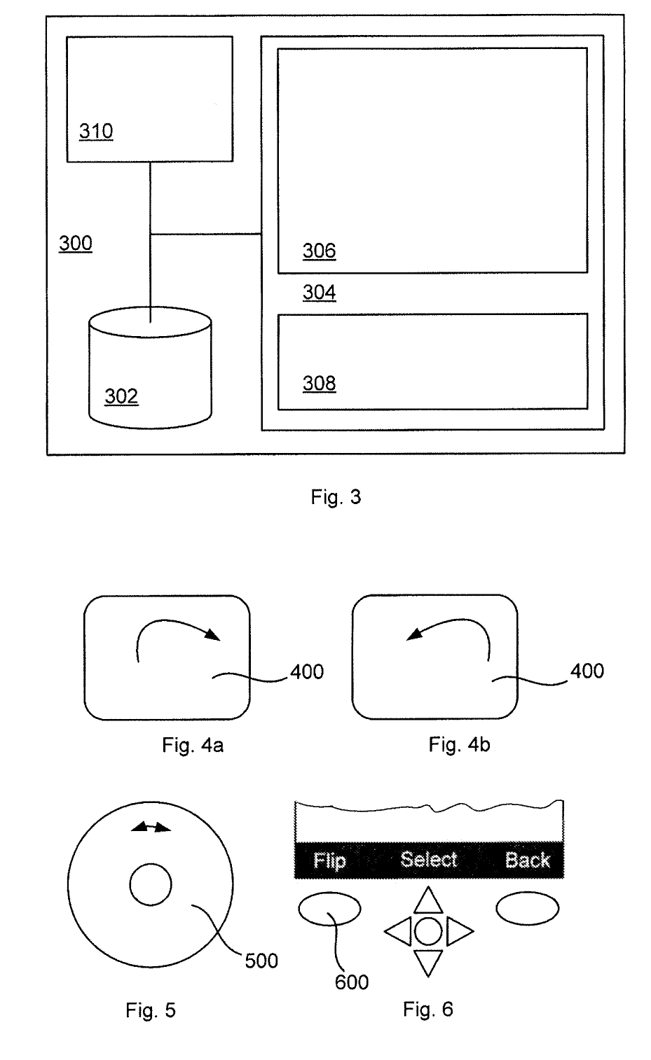

FIG. 3 is schematic view of an apparatus 300 according to an embodiment of the invention. The apparatus 300 comprises a memory 302, a user interface 304 capable of displaying image and text information by a display 306 and capable of receiving a user input by user input means 308, and a processing means 310 for controlling operation of the apparatus 300 and its elements 302, 304, 306, 308.

Operation of the apparatus 300, which is illustrated by the use cases demonstrated with reference to FIGS. 1 and 2, is thus controlled by the processing means 310 such that a content side or a virtual backside of the content is selectively, upon user interaction with the user input means 308, displayed by said display 306. Thus, the virtual backside of the digital media content can comprise an area for notes, where input and/or editing of notes can be made by a user using the user input means 308. The notes can then be stored as meta data for the digital media content, for example in the memory 302.

The notes can for example be text input by text input means, e.g. with capabilities for enhanced text input, such as text prediction aids, and then storing the text, or by a drawing function, such as a touch sensitive area, e.g. a touch pad or a touch screen, and then storing the drawing. A combination of these is also possible, i.e. the two input methods performed in parallel, with storage of both the text and the drawing, or by using the drawing function, and then converting input strokes to text and storing the text.

Upon selection of which side to be viewed, the view on the display 306 is changed between the content side and the virtual backside, or the other way around. This change can be animated to illustrate flipping of the media item, as illustrated in FIG. 2, for example by image processing of the processor 310. The sub-images of the animation can be pre-processed and stored for improving speed of flipping, wherein the pre-processed images are accessed and viewed.

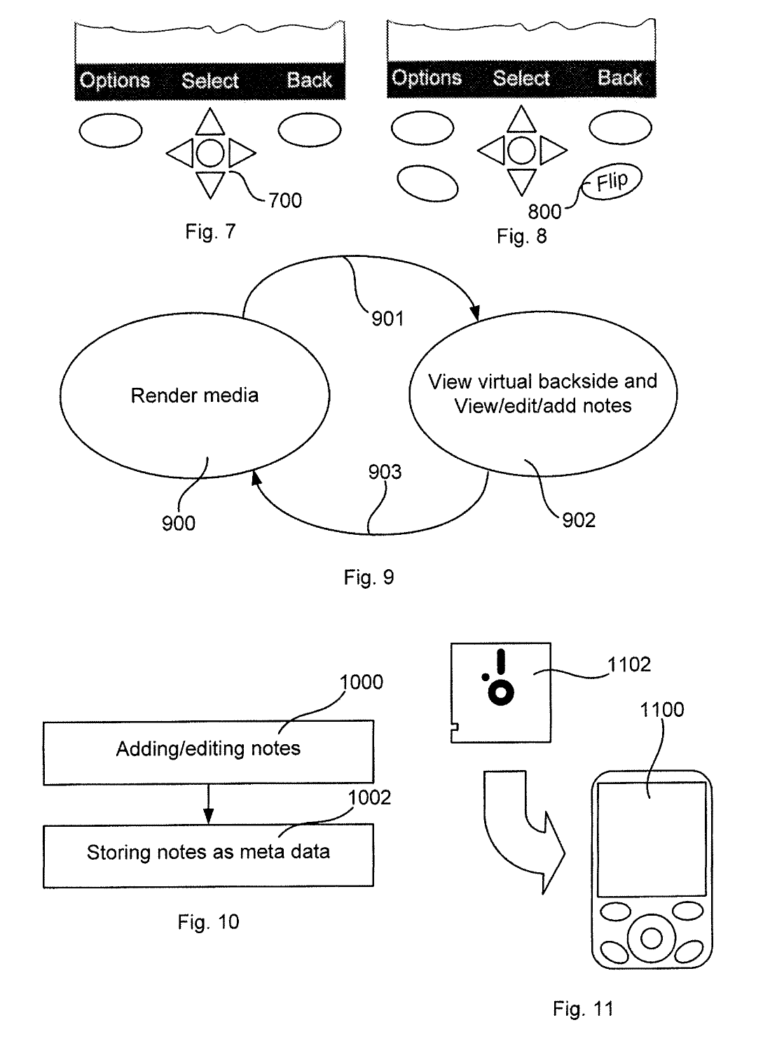

The user input for causing the change from one side to the other can be performed in a multitude of ways, such as making an arc movement on a touch sensitive area 400 of the user input means 308, as illustrated in FIGS. 4a and 4b, such as a touch sensitive display, a touch pad, a touch rotator input, etc., or rotating a rotator input 500, as illustrated in FIG. 5, pressing a soft key 600 which is assigned the function for flipping, as illustrated in FIG. 6, using a navigation key 700, such as a four-way navigator, as illustrated in FIG. 7, or actuating a dedicated flipping key 800, whatever is present in the user input means 308. More options for performing flipping can be presented, and is preferably chosen in such a way that it is intuitive to the user, and preferably in line with the general build-up of the user interface 304.

Note that the memory 302 for storing content can be inside the apparatus 300, outside the apparatus 300 and remotely accessible by the apparatus 300, e.g. via a communications network (not shown), or divided between a partition inside the apparatus 300 and another partition outside the apparatus 300 and remotely accessible by the apparatus 300, e.g. via a communications network.

FIG. 9 illustrates selectable states 900, 902 according to a method according to an embodiment of the disclosed embodiment. In a media rendering state 900, digital media content is rendered, which comprises displaying content of the digital media content. Upon transition 901 to a virtual backside state 902, where the transition 901 comprises flipping according to any of the above demonstrated, a virtual backside of the digital media content is displayed, where an area for notes are present. Upon transition 903 to the media rendering state 900, flipping according to any of the above demonstrated is performed to view the digital media content side.

FIG. 10 is a flow chart schematically illustrating optional method steps performed in the virtual backside state 902, demonstrated with reference to FIG. 9, where a virtual backside comprising an area for notes is viewed. In a note input step 1000, editing and/or adding of notes is enables, where a user can edit and create notes, which can be performed in any way described above. In a meta data storing step 1002, the notes are stored as meta data to the digital media content.

The invention can be computer-implemented, i.e. the media handling is performed on a general or dedicated computerized apparatus, such as a personal computer, a mobile phone, a digital camera, a personal digital assistant, a media player, or other similar apparatus. Instructions for performing the invention can then be executed by the apparatus. These instructions can be loaded into the apparatus 1100 from a computer-readable medium 1102, as exemplary illustrated in FIG. 11, having a data structure stored. The data structure comprises the control instructions which upon execution causes the apparatus to selectively display a content side or a backside, respectively, of a digital media content, wherein the backside comprises an area for notes. Further, control instructions causing the apparatus to store notes of the area as meta data to said digital media content can be provided. Control instructions for enabling adding or editing notes in said area, when the backside is selected for displaying, can also be provided. Control instructions for enabling inputting text in the area, and storing the text as meta data to said digital media content can be provided. Control instructions for enabling inputting image information in said area by actuating a touch sensitive matrix, and storing an input image as meta data to said digital media content can also be provided. Control instructions for receiving a user input indication to toggle between said sides can also be provided. Control instructions for animating change from the present side to the side to be displayed can also be provided. Control instructions for interpreting user input from any of a group comprising an arc movement input on a touch sensitive display, turning a rotatable input means, pressing a soft key, a navigation key, and a dedicated key can also be provided. The data structure is preferably in form of one or more computer programs.

The invention has mainly been described above with reference to a few embodiments. However, as is readily appreciated by a person skilled in the art, other embodiments than the ones disclosed above are equally possible within the scope of the invention, as defined by the appended patent claims.

1. A method comprising
selectively displaying a content side or a backside, respectively, of a digital media content, wherein said backside comprises an area for notes; and
storing notes of said area as meta data to said digital media content.

2. The method according to claim 1, further comprising enabling adding or editing notes in said area when said backside is selected for displaying.

3. The method according to claim 2, further comprising inputting a text in said area; and storing said text as meta data to said digital media content.

4. The method according to claim 2, further comprising inputting an image in said area by actuating a touch sensitive matrix; and storing said image as meta data to said digital media content.

5. The method according to claim 1, further comprising receiving a user input indicating to toggle between said sides.

6. The method according to claim 5, wherein said user input is any of a group comprising
an arc movement input on a touch sensitive matrix, turning a rotatable input means, pressing a soft key, a navigation key, and a dedicated key.

7. The method according to claim 1, further comprising animating a change from the present side to the side to be displayed.

8. An apparatus comprising
a memory arranged to store a digital media content;
a display, and
an input receiver,
wherein said apparatus is arranged to selectively display a content side or a backside, respectively, of said digital media content on said display, wherein said backside comprises an area for notes, and said memory is arranged to store notes of said area as meta data to said digital media content.

9. The apparatus according to claim 8, wherein said input receiver comprises a note input arranged to enable adding or editing of notes in said area when said backside is displayed.

10. The apparatus according to claim 8, wherein said input receiver further comprises a text input arranged for enabling input of a text in said area; and said memory is arranged to store said text as meta data to said digital media content.

11. The apparatus according to claim 8, wherein said input receiver further comprises a touch sensitive matrix arranged for enabling input of an image in said area by actuation of said touch sensitive matrix; and said memory is arranged to store said image as meta data to said digital media content.

12. The apparatus according to claim 8, wherein said input receiver is arranged to receive a user input on selection of side to be displayed among said content side and said backside.

13. The apparatus according to claim 12, wherein said user input is any of a group comprising an arc movement input on a touch sensitive matrix, turning a rotatable input means, pressing a soft key, a navigation key, and a dedicated key.

14. The apparatus according to claim 8, arranged to animate a change from the present side to the side to be displayed in said display.

15. A computer-readable medium having stored thereon a data structure, comprising control instructions for causing an apparatus to selectively display a content side or a backside, respectively, of a digital media content, wherein said backside comprises an area for notes, and to store notes of said area as meta data to said digital media content.

16. The computer-readable medium according to claim 15, wherein said data structure further comprises control instructions for enabling adding or editing notes in said area when said backside is selected for displaying.

17. The computer-readable medium according to claim 15, wherein said data structure further comprises control instructions for enabling inputting text in said area; and storing said text as meta data to said digital media content.

18. The computer-readable medium according to claim 15, wherein said data structure further comprises control instructions for enabling inputting image information in said area by actuating a touch sensitive matrix; and storing an input image as meta data to said digital media content.

19. The computer-readable medium according to claim 15, wherein said data structure further comprises control instructions for receiving a user input indication to toggle between said sides.

20. The computer-readable medium according to claim 15, wherein said data structure further comprises control instructions for animating change from the present side to the side to be displayed.

21. The computer-readable medium according to claim 15, wherein said data structure further comprises control instructions for interpreting user input from any of a group comprising an arc movement input on a touch sensitive matrix, turning a rotatable input means, pressing a soft key, a navigation key, and a dedicated key.

22. An apparatus comprising
means for selectively displaying a content side or a backside, respectively, of a digital media content, wherein said backside comprises an area for notes; and
means for storing notes of said area as meta data to said digital media content.

23. The apparatus according to claim 22, further comprising means for enabling adding or editing notes in said area when said backside displayed.

24. The apparatus according to claim 22, further comprises means for inputting text in said area; and means for storing said text as meta data to said digital media content.

25. The apparatus according to claim 22, further comprises means for inputting image information in said area by actuating a touch sensitive matrix; and means for storing said image as meta data to said digital media content.

26. The apparatus according to claim 22, comprising means for receiving a user input indicating to toggle between said sides.

27. The apparatus according to claim 22, comprising means for animating change from the present side to the side to be displayed.

28. A user interface comprising
a display, and
an input receiver,
wherein said user interface is arranged to selectively display a content side or a backside, respectively, of a digital media content on said display, wherein said backside comprises an area for notes, and said input receiver is arranged to enable adding or editing of notes in said area when said backside is displayed.

29. The user interface according to claim 28, wherein said input receiver further comprises a touch sensitive matrix arranged for enabling input of an image in said area by actuation of said touch sensitive matrix.

30. The user interface according to claim 28, wherein said input receiver is arranged to receive a user input on selection of side to be displayed among said content side and said backside.
